(19) United States
(12) Patent Application Publication
(10) Pub. No.: US 2026/0258163 A1
(43) Pub. Date: Sep. 3, 2026

(54) PROCESSING DEVICE, PROCESSING METHOD, AND METHOD FOR MANUFACTURING POLYMER

(71) Applicant: NITTO DENKO CORPORATION, Ibaraki-shi, Osaka (JP)

(72) Inventors: Tomokazu Takahashi, Osaka (JP); Tomohiro Taruno, Osaka (JP); Takayuki Yamamoto, Osaka (JP)

(73) Assignee: NITTO DENKO CORPORATION, Ibaraki-shi, Osaka (JP)

(21) Appl. No.: 19/163,032

(22) PCT Filed: Jan. 25, 2024
(86) PCT No.: PCT/JP2024/002306

§ 371 Date: Sep. 8, 2025

(30) Foreign Application Priority Data
Mar. 15, 2023 (JP) 2023-040892

(51) Int. Cl. C08F 2/01; B01J 19/00; B01J 19/24

(52) U.S. Cl. CPC C08F 2/01; B01J 19/0073; B01J 19/2415

(57) ABSTRACT

The present invention provides a novel treatment device suitable for taking out a content from a pressure-resistant container. A treatment device (100) of the present invention includes: a pressure-resistant container (10); and a treatment container (20) for holding an object to be treated. The treatment container (20) is removably arranged inside the pressure-resistant container (10). A treatment method using the treatment device (100) of the present invention includes performing treatment of the object inside the treatment container (10) under a state in which a fluid supplied to the inside of the treatment container (10) and the object are brought into contact with each other.

### TECHNICAL FIELD

The present invention relates to a treatment device, a treatment method, and a method of producing a polymer.

### BACKGROUND ART

Hitherto, a pressure-resistant container has been used to subject an object to treatment under a high-pressure atmosphere. Depending on a gas to be introduced into the pressure-resistant container, a supercritical fluid may be formed by sufficient pressurization and heating. The supercritical fluid is a fluid having a lower viscosity and higher diffusivity than those of a liquid, and has a property capable of dissolving an organic substance. According to the supercritical fluid, treatment involving allowing a chemical reaction (e.g., a polymerization reaction) of an object to proceed, treatment involving extracting a component included in an object, and the like can be performed with minimal use of organic solvents.

For example, in Patent Literature 1, there is a description that a polymerization reaction of a group of monomers is allowed to proceed through use of a stainless-steel high-pressure container under a state in which the container is filled with high-pressure carbon dioxide. It is assumed that carbon dioxide is in a supercritical state in the high-pressure container.

### CITATION LIST

### Patent Literature

Patent Literature 1: JP 4368710 B2

### SUMMARY OF INVENTION

### Technical Problem

A pressure-resistant container is generally relatively large and is fixed at an installation place for use. Accordingly, it is difficult to sufficiently take out a content from an upper portion of the pressure-resistant container after treatment of an object. In order to take out the content from the pressure-resistant container, it is also conceived that a discharge port for discharging a content may be arranged in a bottom portion of the pressure-resistant container. However, the discharge port is often adjusted to have a small inner diameter of, for example, about 1 mm or less, from the viewpoint of sufficiently securing the durability of the pressure-resistant container under high pressure. The discharge port having such a small inner diameter is liable to clog at the time of the discharge of a content. This problem may significantly occur particularly when the object is a solid such as powder or when a solid is obtained from the object by the treatment.

Accordingly, an object of the present invention is to provide a novel treatment device suitable for taking out a content from a pressure-resistant container.

### Solution to Problem

According to an embodiment of the present invention, there is provided a treatment device, including:
a pressure-resistant container; and
a treatment container configured to hold an object to be treated,
wherein the treatment container is removably arranged inside the pressure-resistant container.

According to another embodiment of the present invention, there is provided a treatment method using the above-mentioned treatment device,
the treatment method including performing treatment of the object inside the treatment container under a state in which a fluid supplied to the inside of the treatment container and the object are brought into contact with each other.

According to another embodiment of the present invention, there is provided a method of producing a polymer using the above-mentioned treatment device,
the method including allowing a polymerization reaction of a group of monomers to proceed inside the treatment container under a state in which a fluid supplied to the inside of the treatment container and the group of monomers are brought into contact with each other.

### Advantageous Effects of Invention

According to the present invention, the novel treatment device suitable for taking out a content from a pressure-resistant container can be provided.

### BRIEF DESCRIPTION OF DRAWINGS

FIG. 1 is a schematic cross-sectional view of a treatment device according to an embodiment of the present invention.

FIG. 2 is an exploded perspective view of a treatment container included in the treatment device illustrated in FIG. 1.

FIG. 3 is a schematic cross-sectional view for illustrating a modification example of the treatment device.

FIG. 4 is a schematic configuration diagram of a treatment system including the treatment device of the present invention.

FIG. 5 is a schematic configuration diagram for illustrating a modification example of the treatment system.

FIG. 6 is an image of an inside of a pressure-resistant container showing the result of Example 1.

FIG. 7 is an image of an inside of a pressure-resistant container showing the result of Comparative Example 1.

FIG. 8 is a schematic cross-sectional view of a related-art treatment device.

### DESCRIPTION OF EMBODIMENTS

A treatment device according to a first aspect of the present invention includes:
a pressure-resistant container; and
a treatment container configured to hold an object to be treated,
wherein the treatment container is removably arranged inside the pressure-resistant container.

In a second aspect of the present invention, for example, in the treatment device according to the first aspect, the treatment container includes: a tubular main body having a first end surface and a second end surface facing each other; and a bottom portion covering an opening surrounded by the first end surface.

In a third aspect of the present invention, for example, in the treatment device according to the second aspect, the bottom portion includes a supply port configured to supply a fluid to an inside of the treatment container.

In a fourth aspect of the present invention, for example, in the treatment device according to the third aspect, the supply port has arranged therein a check valve configured to allow the fluid to flow from an outside of the treatment container to the inside thereof and to prevent the fluid from flowing from the inside of the treatment container to the outside thereof.

In a fifth aspect of the present invention, for example, in the treatment device according to any one of the second to fourth aspects, the bottom portion is detachable from the main body.

In a sixth aspect of the present invention, for example, in the treatment device according to any one of the second to fifth aspects, the second end surface of the main body includes a connection portion connectable to another member.

In a seventh aspect of the present invention, for example, the treatment device according to any one of the second to sixth aspects further includes a sealing member circumferentially attached to the main body.

In an eighth aspect of the present invention, for example, in the treatment device according to any one of the first to seventh aspects, the pressure-resistant container includes a container body and a lid portion.

In a ninth aspect of the present invention, for example, in the treatment device according to the eighth aspect, a bottom portion of the container body includes a supply port configured to supply a fluid to an inside of the pressure-resistant container.

In a tenth aspect of the present invention, for example, in the treatment device according to the eighth or ninth aspect, the lid portion includes a discharge port configured to discharge a fluid from the inside of the pressure-resistant container.

In an eleventh aspect of the present invention, for example, in the treatment device according to any one of the first to tenth aspects, the object contains a group of monomers, and the treatment allows a polymerization reaction of the group of monomers to proceed.

In a twelfth aspect of the present invention, for example, in the treatment device according to any one of the first to eleventh aspects, treatment of the object is performed inside the treatment container under a state in which a fluid supplied to the inside of the treatment container and the object are brought into contact with each other.

In a thirteenth aspect of the present invention, for example, in the treatment device according to the twelfth aspect, the treatment is performed under a state in which the fluid in a supercritical state is brought into contact with the object.

A treatment method according to a fourteenth aspect of the present invention is a treatment method using the treatment device of any one of the first to thirteenth aspects,
the treatment method including performing treatment of the object inside the treatment container under a state in which a fluid supplied to the inside of the treatment container and the object are brought into contact with each other.

In a fifteenth aspect of the present invention, for example, in the treatment method according to the fourteenth aspect, the treatment is performed under a state in which the fluid in a supercritical state is brought into contact with the object.

In a sixteenth aspect of the present invention, for example, in the treatment method according to the fourteenth or fifteenth aspect, the fluid contains carbon dioxide.

In a seventeenth aspect of the present invention, for example, in the treatment method according to any one of the fourteenth to sixteenth aspects, the object contains a group of monomers, and the treatment allows a polymerization reaction of the group of monomers to proceed.

A method of producing a polymer according to an eighteenth aspect of the present invention is a method of producing a polymer using the treatment device of any one of the first to thirteenth aspects,
the method including allowing a polymerization reaction of a group of monomers to proceed inside the treatment container under a state in which a fluid supplied to the inside of the treatment container and the group of monomers are brought into contact with each other.

Details of the present invention are described below, but the following description is not intended to limit the present invention to a certain embodiment.

### Embodiment of Treatment Device

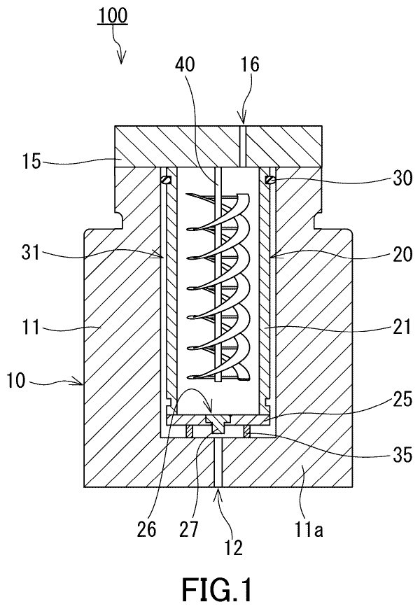

As illustrated in FIG. 1, a treatment device 100 according to an embodiment of the present invention includes a pressure-resistant container 10 and a treatment container 20. The treatment container 20 is a container for holding an object to be treated, and is removably arranged inside the pressure-resistant container 10. The term “removable” herein means that the treatment container 20 can be arranged inside the pressure-resistant container 10 and the treatment container 20 can be taken out from the inside of the pressure-resistant container 10 without breakage of the pressure-resistant container 10 and the treatment container 20. Under a state in which the treatment container 20 is arranged inside the pressure-resistant container 10, the treatment container 20 may be fixed to the pressure-resistant container 10 with a fastener such as a bolt, but is preferably not fixed thereto.

According to the treatment device 100 of this embodiment, after treatment of an object, the treatment container 20 is taken out from the pressure-resistant container 10, and hence a content obtained after the treatment can be easily taken out.

### (Pressure-Resistant Container)

The pressure-resistant container 10 is, for example, a container (pressure container) capable of withstanding an internal pressure of more than 0.1 MPa. In particular, the pressure-resistant container 10 preferably withstands an internal pressure of 1.0 MPa or more, 5.0 MPa or more, 7.0 MPa or more, 10 MPa or more, 15 MPa or more, or 20 MPa or more. The pressure-resistant container 10 is fixed, for example, at the installation place of the treatment device 100.

The pressure-resistant container 10 includes, for example, a container body 11 and a lid portion 15. The container body 11 is bottomed and tubular (particularly cylindrical), and is capable of holding the treatment container 20 inside thereof. The lid portion 15 is a member that is attached to an upper portion of the container body 11 to close an internal space of the container body 11. When an object is to be treated, the lid portion 15 and the container body 11 may be fixed to each other with a fastener, such as a screw or a bolt, or the lid portion 15 may be fixed to the container body 11 by threaded engagement through a screw mechanism.

A bottom portion 11a of the container body 11 includes, for example, a supply port 12 for supplying a fluid to the inside of the pressure-resistant container 10. The supply port 12 is, for example, a nozzle-shaped opening and penetrates through the bottom portion 11a of the container body 11 in a thickness direction thereof. The internal space and external space of the pressure-resistant container 10 communicate to each other through the supply port 12. For example, the supply port 12 is connected to a pipe (a fluid supply path to be described later).

The bottom portion 11a of the container body 11 may further include a discharge port (not shown) for discharging a content held in the pressure-resistant container 10 (e.g., a fluid present in a gap between the pressure-resistant container 10 and the treatment container 20 after the treatment of an object) to the outside of the pressure-resistant container 10. The discharge port is, for example, a nozzle-shaped opening and penetrates through the bottom portion 11a of the container body 11 in the thickness direction thereof. The internal space and external space of the pressure-resistant container 10 communicate to each other through the discharge port. For example, the discharge port is connected to a pipe.

The internal volume of the container body 11 is, for example, 100 mL or more, and may be 500 mL or more, 2 L or more, 20 L or more, 100 L or more, or 200 L or more. The upper limit of the internal volume of the container body 11 is, for example, less than 1000 L, and may be 500 L or less. The container body 11 having an internal volume of 1000 L or more has an excessively large weight and is difficult to handle.

The lid portion 15 includes, for example, a discharge port 16 for discharging a fluid from the inside of the pressure-resistant container 10. The discharge port 16 is, for example, a nozzle-shaped opening and penetrates through the lid portion 15 in the thickness direction thereof. The internal space and external space of the pressure-resistant container 10 communicate to each other through the discharge port 16. For example, the discharge port 16 is connected to a pipe (a fluid discharge path to be described later).

The lid portion 15 may further include a supply port (not shown) for supplying an object to the inside of the pressure-resistant container 10 (specifically, the treatment container 20). The supply port is, for example, a nozzle-shaped opening and penetrates through the lid portion 15 in the thickness direction thereof. The internal space and external space of the pressure-resistant container 10 communicate to each other through the supply port. For example, the supply port is connected to a pipe. The discharge port 16 may be used as the supply port.

The lid portion 15 is configured, for example, so that a stirring blade to be described later can be set thereto. Specifically, the lid portion 15 includes a bearing for supporting a shaft of the stirring blade, and the shaft of the stirring blade and a motor arranged outside the pressure-resistant container 10 can be connected to each other via the bearing. With this configuration, the stirring blade arranged inside the pressure-resistant container 10 can be rotated by the motor while the container body 11 is closed by the lid portion 15. The bearing is not particularly limited, but, for example, a dry bearing capable of maintaining performance even under high pressure is used.

The container body 11 and the lid portion 15 are each formed of, for example, a metal material such as stainless steel.

### (Treatment Container)

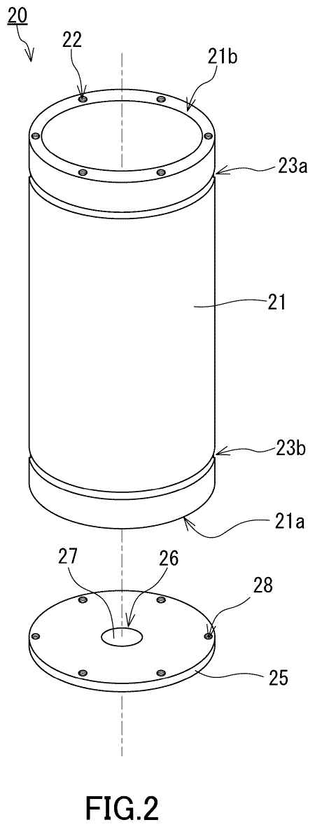

As illustrated in FIG. 1 and FIG. 2, the treatment container 20 includes, for example, a tubular (particularly cylindrical) main body 21 and a bottom portion 25. The main body 21 includes, for example, a first end surface 21a and a second end surface 21b facing each other, and is configured so that the bottom portion 25 may cover an opening surrounded by the first end surface 21a. Specifically, the bottom portion 25 covers the first end surface 21a and the opening surrounded by the first end surface 21a.

The bottom portion 25 and the main body 21 are fixed to each other while the treatment container 20 is arranged inside the pressure-resistant container 10. As an example, the first end surface 21a of the main body 21 includes a connection portion (not shown) connectable to another member, and the bottom portion 25 includes a through hole 28 that penetrates through the bottom portion 25 in the thickness direction thereof. The connection portion of the first end surface 21a is typically a screw portion that functions as a female screw. The bottom portion 25 and the main body 21 can be fixed to each other by screwing a fastener, such as a screw or a bolt, into the connection portion of the first end surface 21a through the through hole 28 of the bottom portion 25.

With the above-mentioned configuration, the bottom portion 25 can be detached from the main body 21 by removing the fastener. Thus, the bottom portion 25 is preferably detachable from the main body 21. In this case, after an object is treated in the treatment device 100, the treatment container 20 is taken out from the pressure-resistant container 10, and the bottom portion 25 of the treatment container 20 is detached from the main body 21. Thus, a content obtained after the treatment can be more easily taken out. However, the bottom portion 25 may be integrated with the main body 21 such that the bottom portion 25 cannot be detached from the main body 21.

The second end surface 21b of the main body 21 includes, for example, a connection portion 22 connectable to another member. As an example, when another member is connected to the connection portion 22 after the treatment of an object in the treatment device 100, the other member may be grasped to easily take out the treatment container 20 from the pressure-resistant container 10. Typically, the connection portion 22 is a screw portion that functions as a female screw, and the other member is a member having a screw portion that functions as a male screw. Examples of the member having a screw portion include a bolt and a screw.

The main body 21 includes, for example, grooves 23a and 23b formed on an external wall of the main body 21. The grooves 23a and 23b each extend in a ring shape in a circumferential direction of the main body 21, and specifically in a direction perpendicular to a longitudinal direction of the main body 21. The groove 23a is formed in the vicinity of the second end surface 21b of the main body 21, and the groove 23b is formed in the vicinity of the first end surface 21a. When a sealing member to be described later is arranged, the grooves 23a and 23b are suitable for fixation of the sealing member.

While the treatment container 20 is arranged inside the pressure-resistant container 10, a gap 31 is present between the external wall of the main body 21 of the treatment container 20 and an inner wall of the container body 11 of the pressure-resistant container 10. The gap 31 is preferably narrow from the viewpoint of treatment efficiency. As an example, a distance between the external wall of the main body 21 and the inner wall of the container body 11 is 1 mm or less.

The bottom portion 25 includes, for example, a supply port 26 for supplying a fluid to the inside of the treatment container 20. The supply port 26 is, for example, a nozzle-shaped opening and penetrates through the bottom portion 25 in the thickness direction thereof. The supply port 26 may be a simple opening. The internal space and external space of the treatment container 20 communicate to each other through the supply port 26. The bottom portion 25 may not include the supply port 26, and the main body 21 may include a supply port.

A valve 27 is preferably arranged in the supply port 26. The valve 27 is typically a check valve for allowing a fluid to flow from the outside of the treatment container 20 to the inside thereof and for preventing a fluid from flowing from the inside of the treatment container 20 to the outside thereof. The valve 27 serving as a check valve is controlled to open only when the pressure of the outside of the treatment container 20 is higher than the pressure of the inside thereof, for example, through use of a spring. Thus, an object held inside the treatment container 20 can be prevented from moving toward the outside. When the valve 27 serving as a check valve is thus arranged, an object held inside the treatment container 20 can be prevented from moving toward the outside of the treatment container 20 (specifically, a gap between the pressure-resistant container 10 and the treatment container 20) through the supply port 26.

The main body 21 and the bottom portion 25 are each formed of, for example, a metal material such as stainless steel.

In an example of FIG. 2, the main body 21 is free of a through hole, which communicates the internal space and external space of the treatment container 20 to each other, in the wall surface. The bottom portion 25 is also free of a through hole, which communicates the internal space and external space of the treatment container 20 to each other, except for the supply port 26. The main body 21 and the bottom portion 25 may each include a through hole in accordance with the object to be held in the treatment container 20 or the treatment to be performed on the object. As an example, the main body 21 and the bottom portion 25 may each be a mesh or a net having formed therein through holes small enough to prevent an object that is a solid from passing therethrough. The treatment container 20 including such main body 21 and bottom portion 25 is suitable for, for example, treatment involving extracting a component included in an object.

### (Sealing Member)

The treatment device 100 further includes, for example, a sealing member 30. The sealing member 30 is circumferentially attached to the main body 21 of the treatment container 20, and specifically is arranged in the groove 23a of the main body 21. For example, the sealing member 30 may be brought into contact with the main body 21 of the treatment container 20 and the container body 11 of the pressure-resistant container 10 to seal the gap 31 between the main body 21 and the container body 11. Thus, clogging of the gap 31 with an object, for example, during the treatment of the object can be suppressed. Specific examples of the sealing member 30 include an O-ring, putty, and a seal tape.

The treatment device 100 may further include an additional sealing member (not shown) arranged in the groove 23b of the main body 21. Examples of the additional sealing member include those described above for the sealing member 30.

### (Support Portion)

The treatment device 100 further includes, for example, a support portion 35. The support portion 35 is a member that is arranged inside the container body 11 of the pressure-resistant container 10 and supports the treatment container 20. Specifically, the support portion 35 is arranged between the bottom portion 11a of the container body 11 and the bottom portion 25 of the treatment container 20, and is in contact with those members.

The support portion 35 has, for example, a ring shape in plan view and surrounds the valve 27 arranged in the bottom portion 25 of the treatment container 20 in plan view. The support portion 35 can prevent impairment of the function of the valve 27 caused by interference of the valve 27 with the pressure-resistant container 10 while the treatment container 20 is arranged inside the pressure-resistant container 10.

### (Stirring Blade)

The treatment device 100 further includes, for example, a stirring blade 40. For example, the stirring blade 40 is capable of stirring an object in the treatment container 20 while the stirring blade 40 is set to the lid portion 15. For example, the stirring blade 40 is connected to a motor (not shown) arranged outside the pressure-resistant container 10.

In an example of FIG. 1, the stirring blade 40 is a helical ribbon blade. The shape of the stirring blade 40 is not particularly limited, and may be appropriately adjusted in accordance with the object to be held in the treatment container 20 or the treatment to be performed on the object. In some cases, the treatment device 100 may be free of the stirring blade 40.

### (Treatment Method)

In an embodiment of the present invention, a treatment method using the treatment device 100 includes, for example, performing treatment of the object inside the treatment container 20 under a state in which a fluid supplied to the inside of the treatment container 20 and the object are brought into contact with each other.

Examples of the fluid to be brought into contact with the object include a gas, a liquid, a high pressure gas, a subcritical fluid, and a supercritical fluid. A supercritical fluid is preferred. As an example, in the treatment method of this embodiment, the treatment is performed under a state in which a fluid in a supercritical state is brought into contact with an object. When a supercritical fluid is used as described above, treatment involving allowing a chemical reaction (e.g., a polymerization reaction) of the object to proceed, treatment involving extracting a component included in the object, and the like can be performed with minimal use of organic solvents.

The composition of the fluid is not particularly limited, and may be appropriately adjusted in accordance with the object or the treatment to be performed on the object. Examples of the component of the fluid include carbon dioxide and water. The fluid preferably contains carbon dioxide, and more preferably consists essentially of carbon dioxide. The expression “consist essentially of” herein means that other components that change the essential characteristics of the mentioned material are excluded, and, for example, the fluid is formed of 95 wt % or more, or 99 wt % or more of the material.

In a preferred embodiment of the present invention, the object contains a group of monomers, and the treatment of the object allows a polymerization reaction of the group of monomers to proceed. Thus, a polymer can be synthesized. According to another aspect of the present invention, there is provided a method of producing a polymer using the treatment device 100,
the method including allowing a polymerization reaction of a group of monomers to proceed inside the treatment container 20 under a state in which a fluid supplied to the inside of the treatment container 20 and the group of monomers are brought into contact with each other.

A treatment method in the case where the object contains a group of monomers (method of producing a polymer) is described below in detail. In this embodiment, the object containing the group of monomers is typically a liquid monomer composition. Accordingly, in this embodiment, the object may be referred to as “monomer composition.” In addition, in this embodiment, the treatment container 20 functions as a reaction container. The treatment device 100 functions as a polymerization device.

First, the treatment container 20 is arranged inside the container body 11 of the pressure-resistant container 10. Next, the monomer composition is set inside the treatment container 20. The treatment container 20 including the monomer composition set in advance may be arranged inside the container body 11.

The group of monomers includes, for example, a (meth)acrylic monomer. The term “(meth)acryl” as used herein means acryl and/or methacryl. The term “(meth)acrylate” means acrylate and/or methacrylate.

Examples of the (meth)acrylic monomer include (meth)acrylic acid, a (meth)acrylic acid alkyl ester, a non-aromatic ring-containing (meth)acrylic monomer, an aromatic ring-containing (meth)acrylic monomer, a hydroxyl group-containing (meth)acrylic monomer, an epoxy group-containing (meth)acrylic monomer, an alkoxy group-containing (meth)acrylic monomer, an amide group-containing (meth)acrylic monomer, a cyano group-containing (meth)acrylic monomer, an amino group-containing (meth)acrylic monomer, an isocyanate group-containing (meth)acrylic monomer, an aziridine group-containing (meth)acrylic monomer, a halogen atom-containing (meth)acrylic monomer, a silicon atom-containing (meth)acrylic monomer, and a polyfunctional (meth)acrylic monomer.

Examples of the (meth)acrylic acid alkyl ester include (meth)acrylic acid alkyl esters each having an alkyl group having 1 to 20 carbon atoms [(meth)acrylic acid C₁₋₂₀ alkyl esters], such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate.

Examples of a non-aromatic ring in the non-aromatic ring-containing (meth)acrylic monomer include: non-aromatic alicyclic rings (e.g., cycloalkane rings, such as a cyclopentane ring, a cyclohexane ring, a cycloheptane ring, and a cyclooctane ring; and cycloalkene rings such as a cyclohexene ring); non-aromatic bridged rings (e.g., bridged hydrocarbon rings, such as dicyclic hydrocarbon rings in, for example, pinane, pinene, bornane, norbornane, and norbornene; tricyclic hydrocarbon rings in, for example, adamantane; and tetracyclic hydrocarbon rings). Examples of the non-aromatic ring-containing (meth)acrylic monomer include: (meth)acrylic acid cycloalkyl esters, such as cyclopentyl (meth)acrylate, cyclohexyl (meth)acrylate, cyclohetpyl (meth)acrylate, and cyclooctyl (meth)acrylate; and (meth)acrylic acid esters each having a non-aromatic bridged ring, such as bornyl (meth)acrylate and isobornyl (meth)acrylate.

Examples of an aromatic ring in the aromatic ring-containing (meth)acrylic monomer include aromatic hydrocarbon rings (e.g., a benzene ring, and a condensed carbon ring in, for example, naphthalene) and various aromatic heterocycles. Specific examples of the aromatic ring-containing (meth)acrylic monomer include: (meth)acrylic acid aryl esters, such as phenyl (meth)acrylate and naphthyl (meth)acrylate; (meth)acrylic acid aryloxyalkyl esters such as phenoxyethyl (meth)acrylate; and (meth)acrylic acid arylalkyl esters such as (meth)acrylic acid benzyl ester.

Examples of the hydroxyl group-containing (meth)acrylic monomer include: (meth)acrylic acid hydroxyalkyl esters, such as 2-hydroxyethyl (meth)acrylate and 2-hydroxypropyl (meth)acrylate; and (meth)acrylic acid monoester forms of (mono-or poly-)alkylene glycols, such as a (meth)acrylic acid monoester form of polyethylene glycol and a (meth)acrylic acid monoester form of polypropylene glycol.

Examples of the epoxy group-containing (meth)acrylic monomer include glycidyl (meth)acrylate and methylglycidyl (meth)acrylate. Examples of the alkoxy group-containing (meth)acrylic monomer include alkoxyalkyl (meth)acrylates, such as methoxyethyl (meth)acrylate and ethoxyethyl (meth)acrylate.

Examples of the amide group-containing (meth)acrylic monomer include: (meth)acrylamide; and (N-substituted) (meth)acrylamides, such as N,N-dimethyl (meth)acrylamide, N-butyl (meth)acrylamide, and N-hydroxy (meth)acrylamide. An example of the cyano group-containing (meth)acrylic monomer is (meth)acrylonitrile (acrylonitrile or methacrylonitrile). Examples of the amino group-containing (meth)acrylic monomer include: aminoalkyl (meth)acrylates such as aminoethyl (meth)acrylate; and (N-substituted) aminoalkyl (meth)acrylates, such as N,N-dimethylaminoethyl (meth)acrylate and t-butylaminoethyl (meth)acrylate. An example of the isocyanate group-containing (meth)acrylic monomer is 2-(meth)acryloyloxyethyl isocyanate. An example of the aziridine group-containing (meth)acrylic monomer is (meth)acryloylaziridine.

An example of the halogen atom-containing (meth)acrylic monomer is 2-chloroethyl (meth)acrylate. Examples of the silicon atom-containing (meth)acrylic monomer include: (meth)acryloyloxyalkyltrialkoxysilanes such as γ-(meth)acryloyloxypropyltrimethoxysilane; and (meth)acryloyloxyalkyl(di- or mono-)alkoxysilanes corresponding to the (meth)acryloyloxyalkyltrialkoxysilanes.

Examples of the polyfunctional (meth)acrylic monomer include hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, glycerin di(meth)acrylate, trimethylolpropane tri(meth)acrylate, pentaerythritol tri(meth)acrylate, dipentaerythritol hexa(meth)acrylate, epoxy acrylate, polyester acrylate, urethane acrylate, divinylbenzene, butyl di(meth)acrylate, and hexyl di(meth)acrylate.

The group of monomers may further include monomers (copolymerizable monomers) copolymerizable with the (meth)acrylic monomers. Examples of the copolymerizable monomer include: carboxyl group-containing vinyl-based monomers, such as itaconic acid, maleic acid, fumaric acid, crotonic acid, and isocrotonic acid, and acid anhydrides thereof (e.g., maleic anhydride and itaconic anhydride); vinyl ester-based monomers, such as vinyl acetate and vinyl propionate; styrene-based monomers, such as styrene, α-methylstyrene, and vinyltoluene; olefin-based monomers, such as ethylene, propylene, isoprene, and butadiene; halogen atom-containing monomers, such as vinyl chloride and vinylidene chloride; vinyl ether-based monomers, such as methyl vinyl ether and ethyl vinyl ether; imide group-containing monomers, such as N-cyclohexylmaleimide and N-isopropylmaleimide; sulfonic acid group-containing monomers such as sodium vinylsulfonate; phosphoric acid group-containing monomers such as 2-hydroxyethyl acryloyl phosphate; and heterocycle-containing vinyl-based monomers, such as N-vinyl-2-pyrrolidone, N-vinylpyridine, N-vinylpiperidone, N-vinylpyrimidine, N-vinylpiperazine, N-vinylpyrazine, N-vinylpyrrole, N-vinylimidazole, and N-vinyloxazole.

The monomer composition may further contain a polymerization initiator. The polymerization initiator is not particularly limited, and a polymerization initiator appropriately selected from those used in general radical polymerization may be used. Examples of the polymerization initiator include a thermally-degradable polymerization initiator and a photoinitiator (photopolymerization initiator) to be decomposed by a light beam such as ultraviolet light.

When the polymerization is performed at a temperature of from 40° C. to 100° C., examples of the thermally-degradable polymerization initiator that may be used include: peroxide-based polymerization initiators, such as benzoyl peroxide, t-hexyl peroxy-2-ethyl hexanoate, t-butyl hydroperoxide, di-t-butyl peroxide, t-butyl peroxybenzoate, dicumyl peroxide, 1,1-bis(t-butylperoxy)-3,3,5-trimethylcyclohexane, and 1,1-bis(t-butylperoxy)cyclododecane; and azo-based polymerization initiators, such as 2,2′-azobisisobutyronitrile, 2,2′-azobisisovaleronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′- azobis(cyclohexane-1-carbonitrile), 2,2′-azobis(2,4,4-trimethylpentane), and dimethyl-2,2′-azobis(2-methyl propionate). In addition, when the polymerization is performed at a temperature of from 20° C. to 40° C., an example thereof is a binary initiator (redox-based initiator) of benzoyl peroxide and dimethylaniline.

Examples of the photoinitiator (photopolymerization initiator) that may be used include 2,2-dimethoxy-1,2-diphenylethan-1-one, 1-hydroxy-cyclohexyl-phenyl-ketone, 2-hydroxy-2-methyl-1-phenyl-propan-1-one, and bis(2,4,6-trimethylbenzoyl)-phenylphosphine oxide). The initiator decomposition rate of the photoinitiator is hardly affected by a polymerization temperature, and hence when the photoinitiator is used as the polymerization initiator, the polymerization temperature may be substantially any temperature.

The usage amount of the polymerization initiator has only to be a usage amount that is usually used in polymerization of a (meth)acrylic monomer, and is, for example, from 0.005 part by weight to 20 parts by weight, preferably from 0.05 part by weight to 15 parts by weight, with respect to 100 parts by weight of the group of monomers.

The monomer composition may further contain a chain transfer agent. With the chain transfer agent, for example, the weight-average molecular weight of a polymer obtained by polymerization of the group of monomers is easily adjusted to a small value of about 100000 or less, for example. Examples of the chain transfer agent include an alkyl mercaptan having 1 to 15 carbon atoms (e.g., lauryl mercaptan), benzyl mercaptan, glycidyl mercaptan, thioglycolic acid, 2-ethylhexyl thioglycolate, 3-mercaptopropionic acid, α-thioglycerol, 2-mercaptoethanol, benzyl alcohol, α-methylbenzyl alcohol, 2,3-dimercapto-1-propanol, and α-methylstyrene dimer. In addition, an oligomer, such as rosin acid, a rosin ester, or a terpene resin, may also be used instead of the chain transfer agent for the adjustment of a molecular weight.

The usage amount of the chain transfer agent is not particularly limited, and is, for example, from 0.005 part by weight to 20 parts by weight, preferably from 0.05 part by weight to 10 parts by weight, with respect to 100 parts by weight of the group of monomers.

The monomer composition may contain a small amount of an organic solvent, such as toluene, hexane, or ethyl acetate, an emulsifier, a dispersant, or the like, but is preferably free thereof.

Next, the lid portion 15 is attached to an upper portion of the container body 11 of the pressure-resistant container 10, and the internal space of the container body 11 is closed. An inert gas is supplied to the inside of the pressure-resistant container 10 from the supply port 12 of the container body 11 while the discharge port 16 of the lid portion 15 is opened. Examples of the inert gas include carbon dioxide, nitrogen, and argon, and carbon dioxide is preferred.

The inert gas supplied from the supply port 12 is transferred to the inside of the treatment container 20 through the supply port 26 in the bottom portion 25 of the treatment container 20. In the inside of the treatment container 20, the inert gas is brought into contact with the monomer composition. Thus, an oxygen concentration in the monomer composition can be reduced. In particular, in the treatment device 100 of this embodiment, the supply port 26 is positioned in the bottom portion 25 of the treatment container 20. Accordingly, when the inert gas is introduced into the inside of the treatment container 20, the monomer composition is subjected to bubbling treatment. This treatment tends to enable the oxygen concentration in the monomer composition to be efficiently reduced. When a check valve is arranged as the valve 27 in the supply port 26 as described above, the monomer composition can be prevented from being transferred to the outside of the treatment container 20 (a gap between the pressure-resistant container 10 and the treatment container 20) in the bubbling treatment.

The inert gas transferred to the inside of the treatment container 20 is discharged to the outside of the treatment device 100 through the discharge port 16 of the lid portion 15. By this operation, the internal space of the treatment device 100 is filled with the inert gas.

Next, the discharge port 16 of the lid portion 15 is closed to seal the internal space of the pressure-resistant container 10. Specifically, a valve of a pipe connected to the discharge port 16 is closed to seal the internal space of the pressure-resistant container 10. In this state, a fluid is supplied from the supply port 12 of the container body 11 to the inside of the pressure-resistant container 10. The fluid supplied from the supply port 12 is typically a gas, and may be the above-mentioned inert gas. This fluid is preferably a carbon dioxide gas. The content of carbon dioxide in the fluid is not particularly limited. The content is, for example, 95 wt % or more, and may be 99 wt % or more, or 99.5 wt % or more.

The usage amount of the fluid is not particularly limited. The usage amount is, for example, 5 parts by weight or more, and may be from 5 parts by weight to 2000 parts by weight, or from 20 parts by weight to 900 parts by weight with respect to 100 parts by weight of the group of monomers.

The fluid supplied from the supply port 12 is transferred to the inside of the treatment container 20 through the supply port 26 of the bottom portion 25 of the treatment container 20. Thus, the pressure in the treatment container 20 is increased. The pressure in the treatment container 20 is adjusted to, for example, 5.0 MPa or more, 5.73 MPa or more, 7.3 MPa or more, or 10 MPa or more. The upper limit of the pressure in the treatment container 20 is not particularly limited. The upper limit is, for example, 40 MPa or less, and may be 30 MPa or less, or 25 MPa or less.

At this time, the temperature in the treatment container 20 is adjusted to, for example, 20° C. or more, 30° C. or more, or 40° C. or more. The upper limit of the temperature in the treatment container 20 is not particularly limited. The upper limit is, for example, 100° C. or less, and may be 90° C. or less, or 70° C. or less. The temperature in the treatment container 20 may be adjusted, for example, by using an external bath electric heater. The temperature in the treatment container 20 may be adjusted by supplying a high temperature fluid from the supply port 12.

In this embodiment, the pressure and the temperature in the treatment container 20 may be appropriately adjusted to convert the fluid in a gas state into a supercritical state. As an example, when the fluid is carbon dioxide, the pressure and the temperature in the treatment container 20 are adjusted to 7.3 MPa or more and 31° C. or more, respectively, to convert carbon dioxide into a supercritical state. In the treatment container 20, a supercritical fluid is mixed with the monomer composition and functions as a diluent for the monomer composition.

For example, when treatment involving adjusting the pressure and the temperature in the treatment container 20 within the above-mentioned ranges is performed, a polymerization reaction of the group of monomers included in the monomer composition proceeds. Thus, a polymer can be synthesized. A time required for the polymerization (polymerization time) is, for example, from 2 hours to 20 hours, and may be from 3 hours to 15 hours, or from 5 hours to 12 hours.

After the completion of the polymerization reaction, the discharge port 16 of the lid portion 15 is opened. Specifically, the valve of the pipe connected to the discharge port 16 is opened to open the discharge port 16. Thus, the fluid is discharged from the inside of the treatment container 20 to the outside of the treatment device 100 through the discharge port 16. As an example, when the discharge port 16 is opened, the pressure in the treatment container 20 is reduced to convert the supercritical fluid into a gas, and the gas is discharged from the discharge port 16.

When the fluid is discharged to the outside of the treatment device 100, a polymer that is a solid (e.g., powder) is deposited in the inside of the treatment container 20. The lid portion 15 of the pressure-resistant container 10 is detached, and the treatment container 20 is taken out from the container body 11. Thus, the above-mentioned polymer can be easily taken out.

In the above-mentioned method, a reaction mixture containing the polymer, and residues, such as the remaining monomer, the polymerization initiator, and the chain transfer agent, is obtained by the polymerization reaction. Accordingly, in the treatment method of this embodiment, an operation for removing the residues from the reaction mixture may be performed after the completion of the polymerization reaction. As an example, after the completion of the polymerization reaction, the reaction mixture is allowed to stand still without opening of the discharge port 16. The reaction mixture is separated into an upper layer containing the fluid (supercritical fluid) as a main component and a lower layer containing the polymer. The residues are generally present in the upper layer. When the upper layer is removed and the lower layer is collected, the content of the residues in the reaction mixture can be reduced, and the polymer can be collected in high purity. This operation may be repeatedly performed by feeding a fresh fluid to the inside of the treatment container 20. The operation herein may be referred to as “washing operation.”

The above-mentioned treatment method is particularly suitable for production of a polymer having a weight-average molecular weight of 100000 or less. In production of a polymer having such low molecular weight, an excessive increase in viscosity of the reaction mixture can be suppressed in the polymerization reaction. The weight-average molecular weight of the polymer is, for example, from 500 to 100000, and may be from 1000 to 50000, from 2000 to 30000, or from 3000 to 10000. The weight-average molecular weight of the polymer may be controlled by the kinds of the polymerization initiator and the chain transfer agent, the usage amounts thereof, the temperature and time of the polymerization, the concentration of the group of monomers, and the like. A polymer having a weight-average molecular weight of 100000 or less (particularly a (meth)acrylic polymer) may be used as a pressure-sensitive adhesive, an adhesive, a paint, or a modifier for a plastic film or the like.

The treatment method of this embodiment may be used, for example, in production of a (meth)acrylic polymer (B) described in JP 2014-74179 A and WO 2011/118183 A1.

The polymer produced by the above-mentioned treatment method may have a weight-average molecular weight of more than 100000 in some cases. The weight-average molecular weight of the polymer is, for example, from 100000 to 3000000, and may be from 200000 to 2000000, or from 300000 to 1500000.

The treatment method of this embodiment is not limited to the treatment of the object containing the group of monomers. For example, when an object contains a compound other than the above-mentioned group of monomers, a chemical reaction of the compound other than the polymerization reaction may be allowed to proceed by the treatment of the object. Further, when an object is a solid, a component included in the object may be extracted by the treatment of the object. A specific example of this treatment is treatment in which coffee beans are brought into contact with a supercritical fluid (particularly, a supercritical fluid of carbon dioxide) so that caffeine may be extracted from the coffee beans.

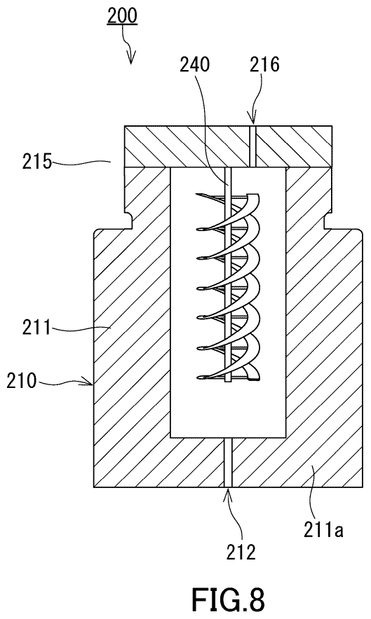

FIG. 8 is a schematic cross-sectional view for illustrating an example of a related-art treatment device 200. The treatment device 200 has the same configuration as that of the treatment device 100 of FIG. 1 except that no treatment container is included. Specifically, the treatment device 200 includes a pressure-resistant container 210, and the pressure-resistant container 210 includes a container body 211 and a lid portion 215. A bottom portion 211a of the container body 211 includes a supply port 212, and the lid portion 215 includes a discharge port 216. The pressure-resistant container 210 is generally fixed at the installation place of the treatment device 200. The treatment device 200 further includes a stirring blade 240.

When treatment is performed on an object in the inside of the treatment device 200 (specifically, the inside of the pressure-resistant container 210) under a state in which the object and a fluid are brought into contact with each other, a content obtained after the treatment remains in the inside of the pressure-resistant container 210, and particularly in the vicinity of the bottom portion 211a of the container body 211. The pressure-resistant container 210 is generally fixed at the installation place of the treatment device 200 as described above, and hence it is difficult to sufficiently take out the content remaining in the vicinity of the bottom portion 211a from the upper portion of the container body 211.

When a discharge port for discharging a content is arranged in the bottom portion 211a, the discharge port is often adjusted to have a small inner diameter of, for example, about 1 mm or less, from the viewpoint of sufficiently securing the durability of the pressure-resistant container 210 under high pressure. The discharge port having such a small inner diameter is liable to clog at the time of the discharge of a content. This problem may significantly occur particularly when the object is a solid such as powder or when a solid is obtained from the object by the treatment. Further, in the treatment device 200, the supply port 212 of the bottom portion 211a may be clogged with the content.

In contrast, the treatment device 100 of this embodiment includes the treatment container 20 removably arranged inside the pressure-resistant container 10. In the treatment device 100, the treatment is performed on the object inside the treatment container 20. Thus, after the treatment of the object, a content obtained after the treatment can be easily taken out by taking out the treatment container 20 from the pressure-resistant container 10. Further, in the treatment device 100 of this embodiment, each port arranged in the pressure-resistant container 10 is less liable to be clogged with the content.

### Modification Example of Treatment Device

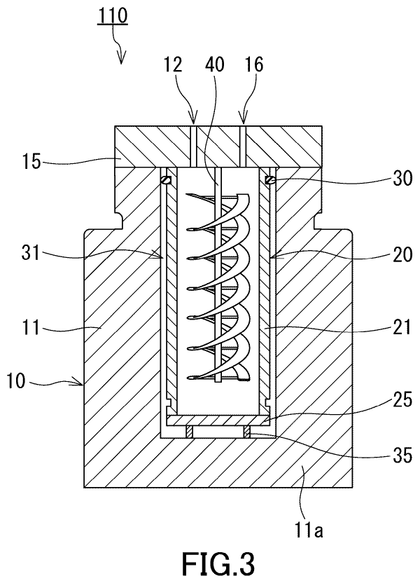

FIG. 3 is a schematic configuration diagram for illustrating a treatment device 110 according to a modification example. In the treatment device 110, the supply port 12 of the pressure-resistant container 10 is arranged in the lid portion 15, not in the bottom portion 11a of the container body 11, as illustrated in FIG. 3. The treatment container 20 is free of the supply port 26 in the bottom portion 25. The structure of the treatment device 110 of this embodiment is the same as the structure of the treatment device 100 except for the above-mentioned configuration. Accordingly, elements common to the treatment device 100 and the treatment device 110 of this embodiment are denoted by the same reference numerals, and description thereof may be omitted. That is, the descriptions of the respective embodiments are applicable to each other as long as no technical inconsistencies arise.

In the treatment device 110, a fluid supplied from the supply port 12 of the lid portion 15 to the inside of the pressure-resistant container 10 is transferred to the inside of the treatment container 20 through an opening surrounded by the second end surface 21b of the main body 21 of the treatment container 20. Thus, the object and the fluid may be brought into contact with each other inside the treatment container 20.

In the treatment device 110, the lid portion 15 may be free of the discharge port 16, and the supply port 12 may also function as a discharge port.

### Embodiment of Treatment System

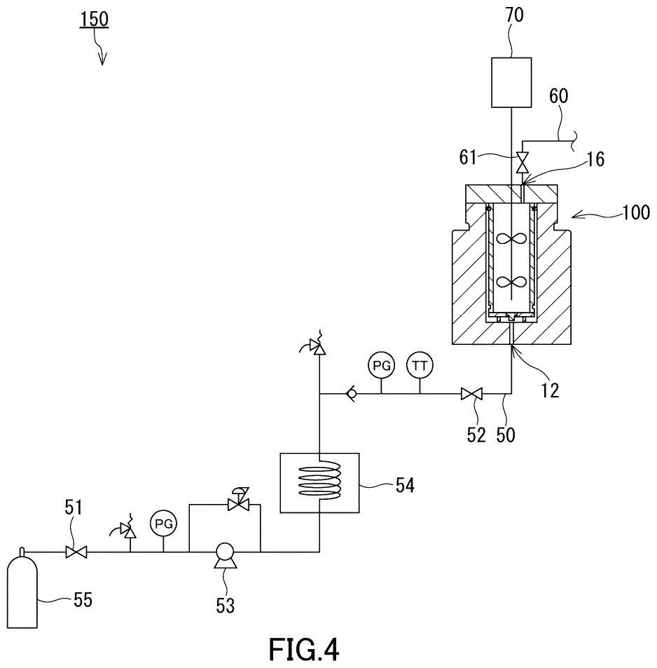

As illustrated in FIG. 4, a treatment system 150 of this embodiment includes the treatment device 100. The treatment system 150 further includes a fluid supply path 50 and a tank 55. The tank 55 stores a fluid and functions as a supply source of the fluid. The tank 55 is, for example, a gas cylinder for storing a gas. The fluid supply path 50 is connected to the tank 55 and the supply port 12 of the pressure-resistant container 10 in the treatment device 100, and is a path for supplying the fluid from the tank 55 to the treatment device 100.

A valve 51, a valve 52, a pressure device 53, and a heat exchanger 54 are arranged in the fluid supply path 50. The valve 51 and the valve 52 are each an on-off valve or a flow rate control valve. For example, the valve 51 is capable of adjusting the flow rate of a fluid to be fed from the tank 55 to the fluid supply path 50. For example, the valve 52 is capable of adjusting the flow rate of a fluid to be fed from the fluid supply path 50 to the treatment device 100.

The pressure device 53 is positioned between the valve 51 and the valve 52, and is capable of pressurizing a fluid fed from the tank 55. Examples of the pressure device 53 include a pressurization pump, a blower, and a back pressure valve. The heat exchanger 54 is positioned between the pressure device 53 and the valve 52, and is, for example, a preheating coil for heating a fluid.

The treatment system 150 further includes a fluid discharge path 60. The fluid discharge path 60 is connected to the discharge port 16 of the pressure-resistant container 10 in the treatment device 100, and is a path for discharging the fluid from the treatment device 100. A valve 61 is arranged in the fluid discharge path 60. The valve 61 is an on-off valve or a flow rate control valve. For example, the valve 61 is capable of adjusting the flow rate of the fluid to be discharged from the treatment device 100.

Each of the paths of the treatment system 150 is formed of, for example, a metal or resin pipe unless otherwise specified.

The treatment system 150 further includes a motor 70. The motor 70 is connected to the stirring blade 40 in the treatment device 100. The motor 70 may be operated to rotate the stirring blade 40.

### Modification Example of Treatment System

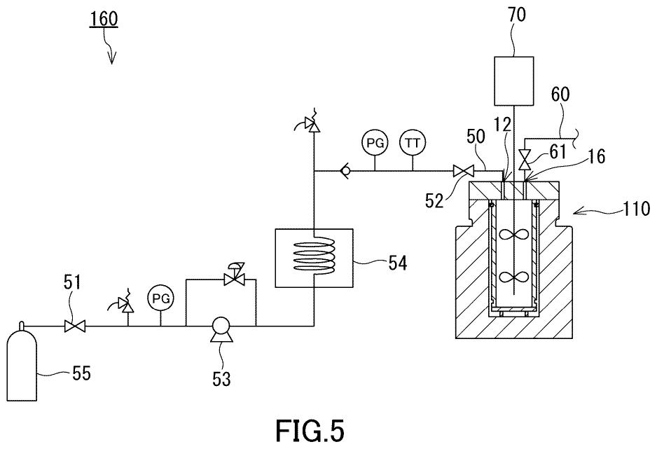

FIG. 5 is a schematic configuration diagram for illustrating a treatment system 160 according to a modification example. As illustrated in FIG. 5, the treatment system 160 includes the treatment device 110 illustrated with reference to FIG. 3. The structure of the treatment system 160 of this embodiment is the same as the structure of the treatment device 100 except for the above-mentioned configuration.

In the treatment system 160, the fluid supply path 50 is connected to the supply port 12 arranged in an upper portion of the treatment device 110 (specifically, the lid portion 15 of the pressure-resistant container 10). A fluid supplied from the tank 55 to the treatment device 110 is transferred to the inside of the treatment container 20 through an opening surrounded by the second end surface 21b of the main body 21 of the treatment container 20, and may be brought into contact with the object inside the treatment container 20.

### EXAMPLES

The present invention is described below in more detail by way of Examples. However, the present invention is by no means limited to Examples described below.

### Example 1

In Example 1, a monomer composition was treated with the treatment device 100 illustrated in FIG. 1 to produce a polymer. Specifically, the treatment container 20 was first arranged inside the container body 11 in the pressure-resistant container 10, and the monomer composition was set inside the treatment container 20. The monomer composition included 50 parts by weight of dicyclopentanyl methacrylate (product name “FANCRYL FA-513M”, manufactured by Resonac Corporation), 50 parts by weight of methyl methacrylate (manufactured by Mitsubishi Gas Chemical Company, Inc.), 2 parts by weight of α-thioglycerol (manufactured by Tokyo Chemical Industry Co., Ltd.) serving as a chain transfer agent, and 7 parts by weight of 2,2′-azobis(2,4-dimethylvaleronitrile) (manufactured by FUJIFILM Wako Pure Chemical Corporation) serving as an initiator.

Next, the lid portion 15 was attached to an upper portion of the container body 11 of the pressure-resistant container 10, and the internal space of the container body 11 was closed. A carbon dioxide gas was supplied from the supply port 12 of the container body 11 to the inside of the pressure-resistant container 10 while the discharge port 16 of the lid portion 15 was opened. The carbon dioxide gas was transferred to the inside of the treatment container 20 through the supply port 26 in the bottom portion 25 of the treatment container 20. Thus, the monomer composition was subjected to bubbling treatment. At this time, a motor connected to the stirring blade 40 was operated to rotate the stirring blade 40.

Next, the discharge port 16 of the lid portion 15 was closed to seal the internal space of the pressure-resistant container 10. In this state, a carbon dioxide gas was supplied from the supply port 12 of the container body 11 to the inside of the pressure-resistant container 10. The carbon dioxide gas was transferred to the inside of the treatment container 20 through the supply port 26 of the bottom portion 25 of the treatment container 20. By this operation, the pressure in the treatment container 20 was increased to 7 MPa.

Next, the treatment device 100 was heated with an external bath electric heater, and the temperature in the treatment container 20 was increased to 70° C. At this time, the carbon dioxide was continuously supplied while the treatment device 100 was heated. At the time point when the temperature in the treatment container 20 reached 80° C., the pressure in the treatment container 20 was 25 MPa. Thus, carbon dioxide in a gas state was converted into a supercritical state in the treatment container 20.

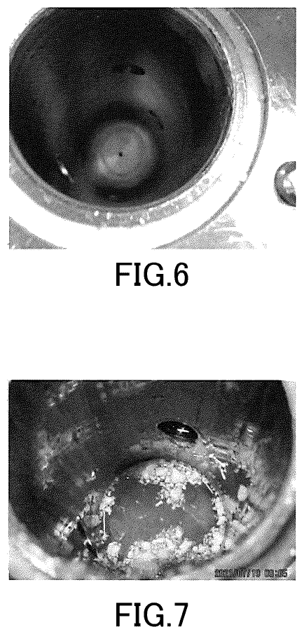

The above-mentioned temperature and pressure were maintained for 10 hours, and a polymerization reaction of a group of monomers was allowed to proceed. As a result, a polymer (weight-average molecular weight: 5000) was obtained. After the completion of the polymerization reaction, the discharge port 16 of the lid portion 15 was opened to discharge carbon dioxide from the inside of the treatment container 20 to the outside of the treatment device 100. The lid portion 15 of the pressure-resistant container 10 was detached, and the treatment container 20 was taken out from the container body 11. Thus, a powdered polymer was collected. After the treatment container 20 was taken out, the inside of the container body 11 was visually observed. As a result, a residue such as a polymer was hardly recognized inside the container body 11 (FIG. 6).

### Comparative Example 1

In Comparative Example 1, a monomer composition was treated and a polymer was produced in the same manner as in Example 1 except that the treatment device 200 illustrated in FIG. 8 was used. After the polymer was scraped from the upper portion of the container body 211 in the pressure-resistant container 210, the inside of the container body 211 was visually observed. As a result, a large amount of a residue such as the polymer remained inside the container body 211 (FIG. 7).

### Industrial Applicability

The treatment device of the present invention can be used in treatment of various objects. In particular, the treatment device is suitable for treatment involving allowing a polymerization reaction of a group of monomers to proceed.

1. A treatment device, comprising:
a pressure-resistant container; and
a treatment container configured to hold an object to be treated,
wherein the treatment container is removably arranged inside the pressure-resistant container.

2. The treatment device according to claim 1, wherein the treatment container includes: a tubular main body having a first end surface and a second end surface facing each other; and a bottom portion covering an opening surrounded by the first end surface.

3. The treatment device according to claim 2, wherein the bottom portion includes a supply port configured to supply a fluid to an inside of the treatment container.

4. The treatment device according to claim 3, wherein the supply port has arranged therein a check valve configured to allow the fluid to flow from an outside of the treatment container to the inside thereof and to prevent the fluid from flowing from the inside of the treatment container to the outside thereof.

5. The treatment device according to claim 2, wherein the bottom portion is detachable from the main body.

6. The treatment device according to claim 2, wherein the second end surface of the main body includes a connection portion connectable to another member.

7. The treatment device according to claim 2, further comprising a sealing member circumferentially attached to the main body.

8. The treatment device according to claim 1, wherein the pressure-resistant container includes a container body and a lid portion.

9. The treatment device according to claim 8, wherein a bottom portion of the container body includes a supply port configured to supply a fluid to an inside of the pressure-resistant container.

10. The treatment device according to claim 8, wherein the lid portion includes a discharge port configured to discharge a fluid from the inside of the pressure-resistant container.

11. The treatment device according to claim 1,
wherein the object contains a group of monomers, and
wherein the treatment allows a polymerization reaction of the group of monomers to proceed.

12. The treatment device according to claim 1, wherein treatment of the object is performed inside the treatment container under a state in which a fluid supplied to the inside of the treatment container and the object are brought into contact with each other.

13. The treatment device according to claim 12, wherein the treatment is performed under a state in which the fluid in a supercritical state is brought into contact with the object.

14. A treatment method using the treatment device of claim 1.
the treatment method comprising performing treatment of the object inside the treatment container under a state in which a fluid supplied to the inside of the treatment container and the object are brought into contact with each other.

15. The treatment method according to claim 14, wherein the treatment is performed under a state in which the fluid in a supercritical state is brought into contact with the object.

16. The treatment method according to claim 14, wherein the fluid contains carbon dioxide.

17. The treatment method according to claim 14,
wherein the object contains a group of monomers, and
wherein the treatment allows a polymerization reaction of the group of monomers to proceed.

18. A method of producing a polymer using the treatment device of claim 1,
the method comprising allowing a polymerization reaction of a group of monomers to proceed inside the treatment container under a state in which a fluid supplied to the inside of the treatment container and the group of monomers are brought into contact with each other.
